(19) United States
(12) Patent Application Publication
(10) Pub. No.: US 2004/0126463 A1
(43) Pub. Date: Jul. 1, 2004

(54) Drops of honey

(76) Inventors: John J. Janik, Kensington, CT (US); Susan B. Janik, Berlin, CT (US); Dorothy L. Carlone, Berlin, CT (US)

Correspondence Address: Dorothy L. Carlone, 43 Devonshire Way, Berlin, CT, 06037, US

(21) Appl. No.: 10/650,912

(22) Filed: Aug. 28, 2003

Related U.S. Application Data
(63) Continuation-in-part of application No. 10/334,827, filed on Dec. 31, 2002, now Pat. No. 6,610,337.

(51) Int. Cl. A23L 1/00

(52) U.S. Cl. 426/98

(57) ABSTRACT

Drops of Honey is a capsule that is filled with honey. This capsule filled with honey is a food product in which the capsule dissolves in boiling water. This allows for the honey to escape into the beverage of choice, preferably tea. It is a food product that will be mainly used with tea and other hot beverages. A method of the product is to sweeten tea. Another method for Drops of Honey is to be used as a dietary supplement. The objective of Drops of Honey is to make it more convenient for the consumer to consume honey within tea or other hot beverages.

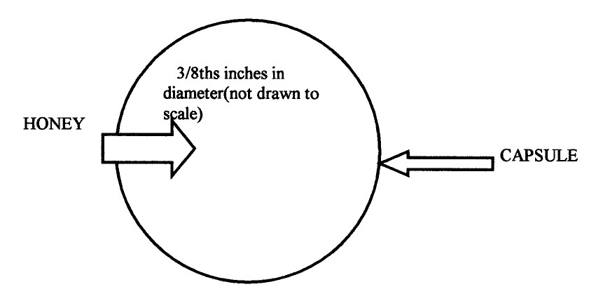

### CROSS-REFERENCE TO RELATED APPLICATIONS

This is a CIP to application Ser. No. 10/334,827 U.S. Pat. No. 6,610,337 made by the same original inventors listed in the Title of Invention section above.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Drops of Honey is a food product to be mainly used with tea and other hot beverages. Drops of Honey is a capsule filled with honey. The capsule dissolves in boiling water and allows for the honey to escape into the beverage of choice.

### BRIEF SUMMARY OF THE INVENTION

Drops of Honey is a capsule filled with honey. It is shaped in the form of a ball that is ⅜ths in diameter. The object of the invention is for the capsule to dissolve in boiling water. This will allow for the honey to then escape in to the beverage of choice. The method of the food product is to sweeten tea. An alternative use for the product is as a dietary supplement providing the vitamins found in honey.

### BRIEF DESCIPTION OF THE SEVERAL VIEWS OF THE DRAWING

The capsule is ⅜ths in diameter and filled with honey.

### DETAILED DESCRIPTION OF THE INVENTION

Drops of Honey is a food product to be mainly used in tea and other hot beverages. The preferred embodiment of Drops of Honey is a capsule made of hydroxymethlcellulose that is filled with honey. The description of the preferred embodiment is a hydroxymethicellulose capsule made from 92% methylcellulose and 8% water. It is shaped in the form of a ball that is ⅜ths in diameter. The hydroxymethlcellulose capsule dissolves in boiling water. This will allow for the honey to escape into the beverage of choice, preferably tea.

We claim:

1. A composition consisting of a capsule consisting of hydroxymethylcellulose, wherein the capsule is filled with honey.

2. A food product consisting of a composition consisting of a capsule consisting of hydroxymethylcellulose, wherein the capsule is filled with honey.

3. A composition consisting of a capsule consisting of gelatin, glycerine and water, wherein the capsule is filled with honey.

4. A food product consisting of a composition consisting of a capsule consisting of gelatin, glycerine and water, wherein the capsule is filled with honey.

5. A composition consisting of a capsule consisting of beef gelatin, glycerine, and water, wherein the capsule is filled with honey.

6. A food product consisting of a composition consisting of a capsule consisting of beef gelatin, glycerine and water, wherein the capsule is filled with honey.

7. A composition consisting of a capsule consisting of pork gelatin, glycerine, and water, wherein the capsule is filled with honey.

8. A food product consisting of a composition consisting of a capsule consisting of pork gelatin, glycerine, and water, wherein the capsule is filled with honey.

9. A composition consisting of a capsule consisting of gelatin and water, wherein the capsule is filled with honey.

10. A food product consisting of a composition consisting of a capsule consisting of gelatin and water, wherein the capsule is filled with honey.

11. A composition consisting of a capsule consisting of beef gelatin, wherein the capsule is filled with honey.

12. A food product consisting of a composition consisting of a capsule consisting of beef gelatin, wherein the capsule is filled with honey.

13. A composition consisting of a capsule consisting of pork gelatin, wherein the capsule is filled with honey.

14. A food product consisting of a composition consisting of a capsule consisting of pork gelatin, wherein the capsule is filled with honey.

15. The method of the food product is to sweeten tea.
